(19) United States
(12) Patent Application Publication
(10) Pub. No.: US 2026/0177070 A1
(43) Pub. Date: Jun. 25, 2026

(54) FAN UNIT

(71) Applicant: SANYO DENKI CO., LTD., Tokyo (JP)

(72) Inventors: Yoshinori MIYABARA, Tokyo (JP); Katsumichi ISHIHARA, Tokyo (JP)

(21) Appl. No.: 19/431,531

(22) Filed: Dec. 23, 2025

(30) Foreign Application Priority Data
Dec. 25, 2024 (JP) 2024-228193

(51) Int. Cl. F04D 29/32; F04D 19/00

(52) U.S. Cl. CPC F04D 29/325; F04D 19/002

(57) ABSTRACT

A fan unit includes: a cup-shaped rotor cover; and a blade member having a cup-shaped boss portion and a blade portion provided to an outer peripheral surface of the boss portion, an outer peripheral surface of the rotor cover and an inner peripheral surface of the boss portion are bonded with an adhesive, a bottom portion of the boss portion is provided with a ring-shaped partition wall, the partition wall separates a space between the bottom portion of the boss portion and a bottom portion of the rotor cover into an inner peripheral area and an outer peripheral area, the outer peripheral area is provided with an adhesive reservoir, and the inner peripheral area is formed with a connecting flow path that connects a space inside the rotor cover and a space outside the boss portion.

### CROSS-REFERENCE TO RELATED APPLICATION

This application is based on Japanese Patent Application No. 2024-228193 filed with the Japan Patent Office on December 25, 2024, the entire content of which is hereby incorporated by reference.

### BACKGROUND

### 1. Technical Field

One aspect of the present disclosure relates to a fan unit.

### 2. Related Art

An axial fan disclosed in Japanese Patent No. 4789492 is provided with an adhesive reservoir space that collects an adhesive that bonds members used for the fan.

### SUMMARY

A fan unit including: a cup-shaped rotor cover configured to rotate around a rotation axis; and a blade member including a cup-shaped boss portion attached to an outer peripheral surface of the rotor cover, and a blade portion provided to an outer peripheral surface of the boss portion, in which the outer peripheral surface of the rotor cover and an inner peripheral surface of the boss portion are bonded with an adhesive, a bottom portion of the boss portion is provided with a ring-shaped partition wall, the partition wall extends in a direction of the rotation axis and is in contact with a bottom portion of the rotor cover to separate a space between the bottom portion of the boss portion and the bottom portion of the rotor cover into an inner peripheral area and an outer peripheral area, the outer peripheral area is provided with an adhesive reservoir, and the inner peripheral area is formed with a connecting flow path that joins a through-hole provided to the boss portion and an opening portion provided to the rotor cover, and connects a space inside the rotor cover and a space outside the boss portion.

### BRIEF DESCRIPTION OF DRAWINGS

FIG. 1 is a cross-sectional view of a fan unit according to an embodiment of the present disclosure;

FIG. 2 is a top view illustrating a blade member according to the embodiment of the present disclosure; and

FIG. 3 is a perspective view illustrating the blade member according to the embodiment of the present disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As disclosed in Japanese Patent No. 4789492, members used for an axial fan may be bonded with an adhesive. Generally, a fan housing of the axial fan may be provided with an opening for passing air therethrough to cool an internal space of the fan housing. A concern about the known axial fan is that the adhesive used to bond members flows into the opening provided to the fan housing and blocks the opening.

One of objects of the present disclosure is to provide a fan unit that can secure an adhesive storing space and an air flow path for cooling a fan with a simple configuration.

A fan unit according to an aspect of the present disclosure includes: a cup-shaped rotor cover configured to rotate around a rotation axis; and a blade member including a cup-shaped boss portion attached to an outer peripheral surface of the rotor cover, and a blade portion provided to an outer peripheral surface of the boss portion, in which the outer peripheral surface of the rotor cover and an inner peripheral surface of the boss portion are bonded with an adhesive, a bottom portion of the boss portion is provided with a ring-shaped partition wall, the partition wall extends in a direction of the rotation axis and is in contact with a bottom portion of the rotor cover to separate a space between the bottom portion of the boss portion and the bottom portion of the rotor cover into an inner peripheral area and an outer peripheral area, the outer peripheral area is provided with an adhesive reservoir, and the inner peripheral area is formed with a connecting flow path that joins a through-hole provided to the boss portion and an opening portion provided to the rotor cover, and connects a space inside the rotor cover and a space outside the boss portion.

According to the one aspect of the present disclosure, it is possible to provide a fan unit that can secure an adhesive storing space and an air flow path for cooling a fan with a simple configuration.

An embodiment of the present disclosure is described hereinafter with reference to the drawings. Note that descriptions of members having the same reference numerals as members already described are omitted in the detailed description for convenience of description. Moreover, the dimensions of each member illustrated in the drawings referred to in the embodiment may be different from actual dimensions thereof for convenience of description.

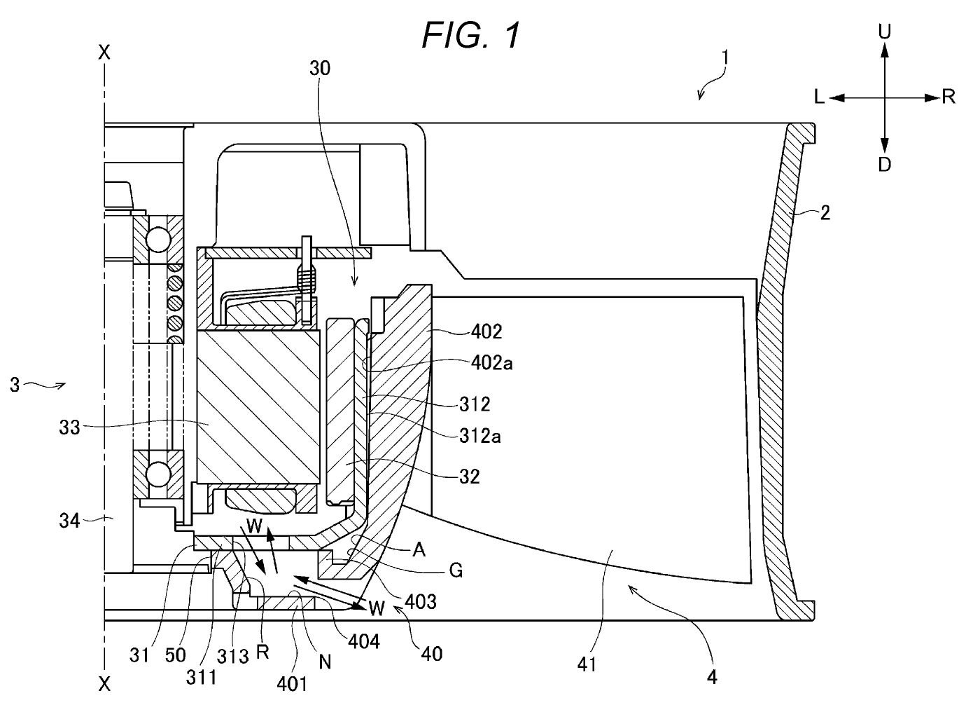

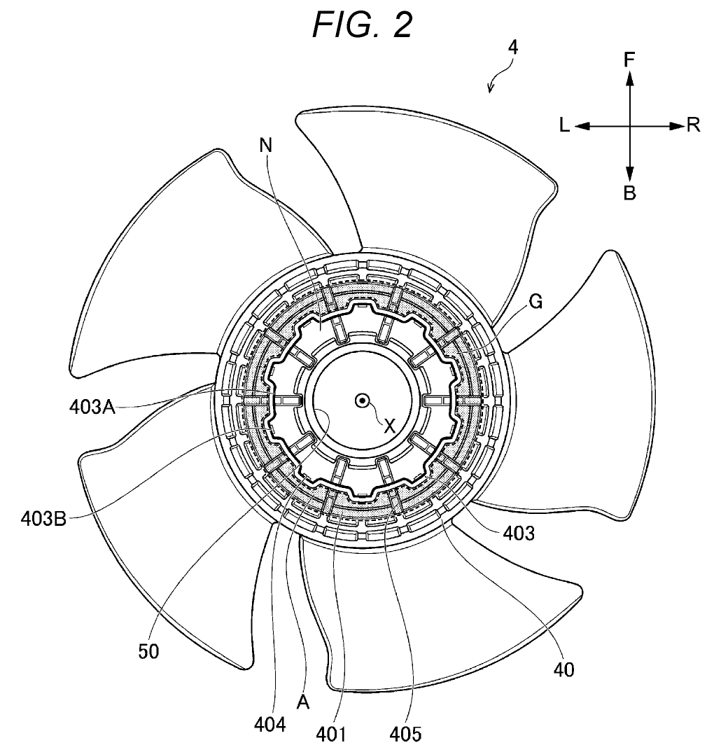

A fan unit 1 according to the embodiment of the present disclosure is described by use of FIGS. 1 and 2. Note that U, D, R, and L illustrated in, for example, FIG. 1 indicate directions in the fan unit 1. U indicates up. D indicates down. R indicates right. L indicates left.

FIG. 1 is a cross-sectional view illustrating an example of an internal structure of the fan unit 1 according to the embodiment of the present disclosure. As illustrated in FIG. 1, the fan unit 1 according to the embodiment of the present disclosure is a fan that can produce a current of air from down D to up U indicated in FIG. 1. The fan unit 1 includes a casing 2, a motor 3, and a blade member 4 that rotates around a rotation axis X relative to the casing 2.

The casing 2 has a box shape. The motor 3 and the blade member 4 are placed in an internal space formed by the casing 2.

The motor 3 can rotate the blade member 4 described below around the rotation axis X. The motor 3 includes a rotor 30, a stator 33, and a rotational shaft portion 34. The motor 3 of the embodiment is an outer rotor motor in which the rotor 30 rotates around the stator 33. The rotor 30 includes a rotor cover 31, and a magnet 32 provided on an inner peripheral surface of the rotor cover 31.

The rotor cover 31 is a member having a cup shape, which can rotate around the rotation axis X. The rotor cover 31 includes a rotor cover bottom portion 311, and a rotor cover side surface portion 312 extending in a direction of the rotation axis X from the perimeter of the rotor cover bottom portion 311. The rotor cover bottom portion 311 and the rotor cover side surface portion 312 form the cup shape of the rotor cover 31. The rotor cover bottom portion 311 is provided with an opening portion 313.

The stator 33 is a nonrotatable member fixed indirectly to the casing 2. The stator 33 is provided with a coil (not illustrated). The motor 3 can magnetize the stator 33 by passing a current to the coil, and rotate the rotor 30 around the rotation axis X. The rotational shaft portion 34 is a member that is fixed to the rotor cover 31 and extends along the rotation axis X.

The blade member 4 is a member that is fixed to the rotor cover 31 and is rotatable around the rotation axis X together with the rotor 30. The blade member 4 includes a boss portion 40, and a blade portion 41 extending from the boss portion 40. The blade portion 41 is provided on an outer peripheral surface of the boss portion 40.

The boss portion 40 is a cup-shaped member fixed to the rotor 30. The boss portion 40 is configured in such a manner as to be capable of accommodating the rotor cover 31 in a space formed in the cup shape. The boss portion 40 includes a boss bottom portion 401 that is circular in top view, a boss side surface portion 402 that extends in the direction of the rotation axis X from the boss bottom portion 401 and forms the cup shape of the boss portion 40, a ring-shaped partition wall 403 provided to the boss bottom portion 401, and a through-hole 404. The boss bottom portion 401 is provided with an opening 50 that can accommodate a part of the rotor cover 31. The boss side surface portion 402 is configured in such a manner as to extend from the perimeter of the boss bottom portion 401 and cover the outer peripheral surface of the rotor cover side surface portion 312.

An inner peripheral surface 402a of the boss side surface portion 402 and an outer peripheral surface 312a of the rotor cover side surface portion 312 are bonded with an adhesive to fix the boss portion 40 to the rotor cover 31. The boss portion 40 and the rotor cover 31 are bonded together by accommodating the rotor cover 31 in the cup-shaped space of the boss portion 40 with the adhesive applied to the inner peripheral surface 402a of the boss side surface portion 402. Note that the boss portion 40 and the rotor cover 31 may be bonded together by introducing the adhesive between the boss side surface portion 402 and the rotor cover side surface portion 312 with the rotor cover 31 accommodated in the boss portion 40.

As illustrated in FIG. 1, the partition wall 403 is a member extending from the boss bottom portion 401 toward the rotor cover 31. The partition wall 403 extends from the boss bottom portion 401 toward the rotor cover 31 and is in contact with the rotor cover bottom portion 311 to form an adhesive reservoir A between the boss bottom portion 401 and the boss side surface portion 402. The adhesive reservoir A can receive and collect excessive adhesive that has not been used for bonding in the adhesive introduced to bond the rotor cover 31 and the boss portion 40. The adhesive reservoir A is provided in an annular shape roughly along the boss bottom portion 401 in top view (refer to FIG. 2).

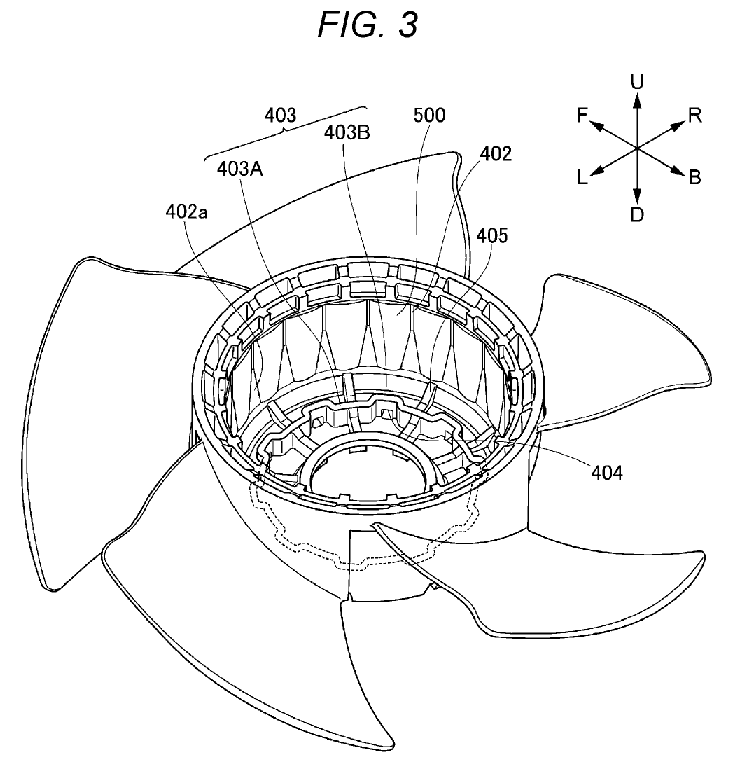

The through-hole 404 is a hole having openings on a boundary between the boss bottom portion 401 and the boss side surface portion 402. Parts of the openings of the through-hole 404 are provided along the partition wall 403 (refer to FIG. 3). The through-hole 404 is a hole that forms a connecting flow path R that causes the inside of the boss portion 40 to communicate with the outside of the boss portion 40. One of the openings of the through-hole 404 of the embodiment is provided in a place provided with at least the partition wall 403 on the boundary between the boss bottom portion 401 and the boss side surface portion 402 (refer to FIG. 3). The other opening of the through-hole 404 is provided in such a manner as to be open to the outside of the boss portion 40. In other words, the two openings of the through-hole 404 are provided along a radial direction of the boss portion 40. The through-hole 404 allows air outside the boss portion 40 to be drawn into the boss portion 40 through the connecting flow path R by forming the connecting flow path R that causes the inside of the boss portion 40 to communicate with the outside of the boss portion 40.

As described above, the rotor cover bottom portion 311 of the rotor cover 31 is provided with the opening portion 313. As indicated with arrows W in FIG. 1, in the fan unit 1 according to the embodiment, the through-hole 404 provided to the boss portion 40 and the opening portion 313 provided to the rotor cover 31 allow air inside the fan unit 1 to be discharged to the outside of the fan unit 1. More specifically, air inside the boss portion 40 and inside the rotor cover 31 can be discharged to the outside of the fan unit 1.

Moreover, as indicated with the arrows W in FIG. 1, the fan unit 1 according to the embodiment can similarly draw air outside the fan unit 1 into the fan unit 1 through the through-hole 404 provided to the boss portion 40 and the opening portion 313 provided to the rotor cover 31. More specifically, the air outside the fan unit 1 can be drawn into the boss portion 40 and into the rotor cover 31. In this manner, the connecting flow path R is configured in such a manner as to join the through-hole 404 provided to the boss portion 40 and the opening portion 313 provided to the rotor cover 31 and connect a space inside the rotor cover 31 and a space outside the boss portion 40.

In the fan unit 1, the partition wall 403 extends in the direction of the rotation axis X and is in contact with the rotor cover bottom portion 311 to separate a space between the boss bottom portion 401 and the rotor cover bottom portion 311 into an inner peripheral area N and an outer peripheral area G. As illustrated in FIG. 1, the adhesive reservoir A is provided in the outer peripheral area G. Moreover, at least parts of the openings of the through-hole 404 illustrated in FIG. 1 are provided to the partition wall 403 (refer to FIG. 3), and cause the inner peripheral area N to communicate with the outside of the boss portion 40 (refer to FIG. 1).

In this manner, the fan unit 1 according to the embodiment of the present disclosure can partition the outer peripheral area G provided with the adhesive reservoir A and the inner peripheral area N that the opening of the through-hole 404 faces, by use of the single partition wall 403.

If the rotor cover 31 and the blade member 4 are bonded with the adhesive, the adhesive is applied to the inner peripheral surface 402a of the boss portion 40 of the blade member 4, and then the boss portion 40 and the rotor cover 31 are bonded together. At this point in time, the adhesive that has run down the bonded portion results in flowing into the boss bottom portion 401 of the boss portion 40. Hence, the boss portion 40 of the fan unit 1 according to the embodiment of the present disclosure is provided with the adhesive reservoir A that allows undesired adhesive to build up therein.

Moreover, heat is generated in the fan unit 1 (in the rotor cover 31 and in the blade member 4) during operation of the fan unit 1. Hence, it is preferable that high-temperature air in the fan unit 1 be discharged to the outside and the fan unit be cooled by drawing in air from the outside. Hence, the boss portion 40 of the fan unit 1 according to the embodiment of the present disclosure is provided with the through-hole 404 extending toward the outside of the boss portion 40. Consequently, the connecting flow path R is formed which passes air from the through-hole 404 into the space in the rotor cover 31 through the opening portion 313 provided to the rotor cover bottom portion 311.

Here, when the rotor cover 31 and the blade member 4 are bonded with the adhesive, if the adhesive that has flowed in also flows into the connecting flow path R, the adhesive that has flowed in may block the through-hole 404 and hinder the function of the connecting flow path R.

The fan unit 1 according to the embodiment of the present disclosure is provided with the partition wall 403. The partition wall 403 separates the space between the boss bottom portion 401 of the boss portion 40 and the rotor cover bottom portion 311 of the rotor cover 31 into the inner peripheral area N and the outer peripheral area G. Consequently, the outer peripheral area G provided with the adhesive reservoir A and the inner peripheral area N that the opening of the through-hole 404 faces are partitioned by the common partition wall 403. Hence, both of the space for the adhesive reservoir A and the space to which the through-hole 404 is open can be secured with a simple configuration. Consequently, both spaces of the adhesive reservoir A and the connecting flow path R can be increased to the maximum.

Next, the blade member 4 of the embodiment is described in detail with reference to FIGS. 2 and 3. FIG. 2 is a top view illustrating an example of the blade member 4 according to the embodiment of the present disclosure.

As illustrated in FIG. 2, the partition wall 403 of the embodiment has a ring shape centered on the rotation axis X in top view. The partition wall 403 separates the boss bottom portion 401 into the outer peripheral area G and the inner peripheral area N in top view. The outer peripheral area G is a portion enclosed by broken lines in FIG. 2. The inner peripheral area N is a portion enclosed by a thick line in FIG. 2. As illustrated in FIG. 2, the adhesive reservoir A is provided in the outer peripheral area, and one of the openings of the through-hole 404 is provided in such a manner as to be open to the inner peripheral area N. In FIG. 2, the adhesive reservoir A is a hatched area.

FIG. 3 is a perspective view illustrating the blade member according to the embodiment of the present disclosure. As illustrated in FIGS. 2 and 3, the partition wall 403 includes first wall portions 403A and second wall portions 403B. The second wall portions 403B are provided radially outward relative to the first wall portions 403A. Moreover, the partition wall 403 is provided in such a manner that the first wall portions 403A alternate with the second wall portions 403B along a circumferential direction in top view.

In the embodiment, at least parts of the openings of the through-hole 404 are provided at positions corresponding to the second wall portions 403B. It is preferable from the viewpoint of fluid dynamics that the through-hole 404 be provided as outward as possible in the radial direction to more efficiently discharge the air in the fan unit 1 to the outside of the fan unit 1. In other words, it is preferable that the partition wall 403 provided with the opening of the through-hole 404 be provided as outward as possible in the radial direction. On the other hand, in terms of the adhesive reservoir A, it is preferable that the partition wall 403 be provided as inward as possible in the radial direction to collect as much adhesive as possible.

In order to solve the above contradictory issue in one go, the partition wall 403 according to the embodiment of the present disclosure is designed by the present inventors to include the first wall portions 403A and the second wall portions 403B provided radially outward of the first wall portions 403A.

In the fan unit 1 according to the embodiment, the second wall portions 403B provided with the opening of the through-hole 404 are provided radially outward of the first wall portions 403A. Hence, it is possible to increase efficiency in drawing air in through the through-hole 404. Moreover, in the fan unit 1 according to the embodiment, the first wall portions 403A are provided radially inward of the second wall portions 403B. Consequently, it is possible to increase the volume of the adhesive reservoir A. Therefore, it is possible to prevent the adhesive from flowing into the connecting flow path R.

Note that it can also be said that the partition wall 403 according to the embodiment includes not the first wall portions 403A and the second wall portions 403B but the recessed portions 403A and the protruding portions 403B. In other words, it can also be expressed that the fan unit 1 according to the embodiment is configured in such a manner that the partition wall 403 is provided alternately in the circumferential direction with the protruding portions 403B and the recessed portions 403A located radially inward of the protruding portions 403B as the boss portion 40 is viewed in the direction of the rotation axis X.

As illustrated in FIGS. 2 and 3, in the embodiment, the boss portion 40 includes a plurality of reinforcing ribs 405 that extends radially from a center point of rotation toward the radially outer side. The reinforcing ribs 405 are provided astride the first wall portions 403A from the inner peripheral area N to the outer peripheral area G. The fan unit 1 according to the embodiment includes the reinforcing ribs 405 with the above configuration and therefore can increase the strength of the entire blade member 4. Moreover, the reinforcing ribs 405 are provided in such a manner as to be astride the first wall portions 403A and therefore do not block the opening of the through-hole 404 provided to the second wall portions 403B.

Moreover, as illustrated in FIG. 3, the height of the reinforcing ribs 405 in the direction of the rotation axis X is lower than the partition wall 403. Specifically, the height of each of the reinforcing ribs 405 in the direction of the rotation axis X in a place that is in contact with the partition wall 403 is lower than the partition wall 403. For example, also if the adhesive is applied excessively to a part of the boss side surface portion 402, the excessive adhesive that has reached the adhesive reservoir A climbs over the reinforcing ribs 405 before climbing over the partition wall 403. The adhesive reservoir A is provided in an annular shape roughly along the boss bottom portion 401 of the boss portion 40 in top view (refer to FIG. 2). Hence, the entire annular adhesive reservoir A can receive the excessive adhesive.

As illustrated in FIG. 3, in the embodiment, the boss side surface portion 402 is formed with a curved surface protruding toward the rotor cover side surface portion 312 (refer to FIG. 1) located radially inward of the boss side surface portion 402. More specifically, the boss side surface portion 402 looks like a shape obtained by attaching, in the circumferential direction, a plate-shaped member 500 having a curved surface protruding toward the rotor cover side surface portion 312 (refer to FIG. 1) to the inner peripheral surface 402a of the boss side surface portion 402. According to the above configuration, a place where the boss side surface portion 402 and the rotor cover side surface portion 312 are in contact with each other, and a place where the boss side surface portion 402 and the rotor cover side surface portion 312 are not in contact with each other with a gap therebetween are formed between the boss side surface portion 402 and the rotor cover side surface portion 312. Hence, the adhesive can be spread efficiently to all over the rotor cover side surface portion 312. Therefore, the bonding efficiency of the adhesive can be increased. Note that one of the outer peripheral surface 312a of the rotor cover 31 or the inner peripheral surface 402a of the boss portion 40 is formed with a curved surface protruding toward the other, and the other may be formed with a plurality of flat surfaces.

Up to this point the embodiments according to the present disclosure have been described. However, it is needless to say that the technical scope of the present disclosure should not be construed in a limited manner by the detailed description. The above-described embodiments are mere exemplifications. Those skilled in the art understand that the above-described embodiments can be modified in various manners within the scope of the disclosure of the claims. The technical scope of the present disclosure should be determined on the basis of the scope of the disclosure of the claims and the scope of equivalents thereof.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A fan unit comprising:
a cup-shaped rotor cover configured to rotate around a rotation axis; and
a blade member including a cup-shaped boss portion attached to an outer peripheral surface of the rotor cover, and a blade portion provided to an outer peripheral surface of the boss portion, wherein
the outer peripheral surface of the rotor cover and an inner peripheral surface of the boss portion are bonded with an adhesive,
a bottom portion of the boss portion is provided with a ring-shaped partition wall,
the partition wall extends in a direction of the rotation axis and is in contact with a bottom portion of the rotor cover to separate a space between the bottom portion of the boss portion and the bottom portion of the rotor cover into an inner peripheral area and an outer peripheral area,
the outer peripheral area is provided with an adhesive reservoir, and
the inner peripheral area is formed with a connecting flow path that joins a through-hole provided to the boss portion and an opening portion provided to the rotor cover, and connects a space inside the rotor cover and a space outside the boss portion.

2. The fan unit according to claim 1, wherein openings of the through-hole are provided along a radial direction.

3. The fan unit according to claim 1, wherein
the partition wall includes first wall portions, and second wall portions provided radially outward of the first wall portions, and
the through-hole is provided to the second wall portions.

4. The fan unit according to claim 1, wherein as the boss portion is viewed in the direction of the rotation axis, the ring-shaped partition wall is provided alternately in a circumferential direction with protruding portions and recessed portions located radially inward of the protruding portions.

5. The fan unit according to claim 3, wherein a plurality of reinforcing ribs extending radially astride the second wall portions is provided.

6. The fan unit according to claim 5, wherein a height of the reinforcing ribs in the direction of the rotation axis is lower than the partition wall.

7. The fan unit according to claim 1, wherein one of the outer peripheral surface of the rotor cover or the inner peripheral surface of the boss portion is formed with a curved surface protruding toward the other, and the other is formed with a plurality of flat surfaces.
